(19) United States
(12) Patent Application Publication
(10) Pub. No.: US 2012/0043688 A1
(43) Pub. Date: Feb. 23, 2012

(54) METHOD AND DEVICE FOR PRODUCING MARKING LABELS

(75) Inventor: Heinz Reibke, Bad Salzuflen (DE)

(73) Assignee: PHOENIX CONTACT GMBH & CO. KG, BLOMBERG (DE)

(21) Appl. No.: 13/146,652

(22) PCT Filed: Jan. 21, 2010
(86) PCT No.: PCT/EP10/00343

§ 371 Date: Oct. 12, 2011

(30) Foreign Application Priority Data
Jan. 31, 2009 (DE) 102009006994.1

(51) Int. Cl. B29C 45/56

(52) U.S. Cl. 264/153; 264/328.1; 425/553

(57) ABSTRACT

The invention relates to a method for producing marking labels for marking electronic components, wherein a mat-shaped injection molded part (10) is produced in a first method step by means of an injection molding process, and marking labels having any arbitrary width and/or length are produced from the mat-shaped injection molded part (10) in a second method step. The invention also relates to a device for producing such marking labels.

The invention relates to a method and to a device for producing marking labels, in particular marking labels for marking electronic components such as terminals, cables and other devices.

Such marking labels are usually made of plastic and are produced in one method step by injecting melted plastic into an injection molding tool using an injection molding process. The dimensions of the marking labels produced are predetermined by the injection molding tool. The finished marking labels are removed from the injection molding tool and can subsequently be imprinted individually. The disadvantage in this regard is, however, that marking labels having different widths and/or lengths are required for different applications, so that a separate injection molding tool has to be produced for each marking label having different dimensions, which is very complex and very expensive. This method is, in particular, very uneconomical, in particular when only small quantities of marking labels have to be produced. In addition, in order to provide the injection molded part with perforations, for example, the injection molding tool has to be constructed such that perforations are generated in the injection molded part during the injection molding process, whereby the production effort and the costs of the injection molding tool are once again considerably increased.

The object of the invention is therefore to provide a method and a device for producing marking labels, in particular marking labels for marking electronic components, by means of which cost-effective and flexible production of marking labels, in particular of marking labels that are only required in limited quantities, is possible.

This object is achieved according to the present invention by the characteristics of the independent claims. Advantageous embodiments of the invention are described in the dependent claims.

The method according to the invention for producing marking labels, in particular marking labels for marking electronic components, preferably comprises a first method step, in which a mat-shaped injection molded part is produced by means of an injection molding process, and a second method step, in which marking labels having variable widths and/or variable lengths are produced from the mat-shaped injection molded part.

According to the invention, the production of marking labels is consequently carried out in two method steps. First, a mat-shaped injection molded part is produced by means of the injection molding process in a first method step. The mat-shaped injection molded part is subsequently processed in a second method step such that marking labels having different dimensions are produced from the mat-shaped injection molded part. The widths and/or lengths of the marking labels can be varied as required, depending on the intended purpose. As a result of the fact that the dimensions of the marking labels are not already determined in the first method step, this being during the injection molding process, but not until the second method step, a uniform injection molding tool can be used for all marking labels. It is thus no longer necessary to produce a separate injection molding tool for each marking label, whereby a considerable cost reduction can be achieved. Moreover, the method according to the present invention is very flexible because the widths and/or the lengths of the marking labels can be adjusted individually and quickly because this can be carried out independently of the injection molding process and of the injection molding tool employed for that purpose.

According to an advantageous embodiment of the invention, in the second method step, the mat-shaped injection molded part is cut in a cutting device, punched in a punching device and/or perforated in a perforating device. The dimensions of the respective marking label are, in particular, established in a simple method step notably by means of cutting and punching. To this end, one or more marking labels can be produced from a mat-shaped injection molded part. Predetermined breaking points can, for example, be generated in the mat-shaped injection molded part by perforating, said breaking points representing the edges of the marking labels so that the user can easily cut the marking labels out of the mat-shaped injection molded part at any time. It is easily and cost-effectively possible to create the desired dimensions of the marking labels to be produced by means of cutting, punching or perforating, wherein special dimensions can be easily produced for each individual marking label, whereby high flexibility can be achieved during manufacturing.

According to another advantageous embodiment of the invention, the mat-shaped injection molded part injected into an injection molding tool in the first method step is removed from the injection molding tool by means of a gripper, and the removed mat-shaped injection molded part is fed to the cutting device, the punching device and/or the perforating device by means of the gripper to carry out the second method step. The gripper can easily and quickly feed the mat-shaped injection molded part produced in the first method step to the second method step by means of a simple design configuration, after the part has cured. For this purpose, the cutting device, the punching device and/or the perforating device are preferably arranged directly next to the injection molding machine, in particular directly next to the injection molding tool, so that the gripper has to cover the shortest possible path when transporting the mat-shaped injection molded part, and the gripper can insert the mat-shaped injection molded part directly into the cutting device, the punching device and/or the perforating device.

According to a preferred embodiment of the invention, the mat-shaped injection molded part can be cut, punched or perforated by means of a laser in order to achieve a particularly quick and effective method. Clean cutting edges without burrs can be achieved by using a laser. Moreover, very fine contours and radial-free inner edges can be cut by means of the laser. Furthermore, the thermal effect is low with laser processes, so that the material of the mat-shaped injection molded part to be processed is not damaged.

The mat-shaped injection molded parts produced in the first method step can have different configurations.

According to an advantageous embodiment of the invention, a mat-shaped injection molded part that has a one-piece surface is produced in a first method step, wherein marking labels having any arbitrary width and any arbitrary length can be produced from this surface. Such mat-shaped injection molded parts have particularly high flexibility when they are further processed because several marking labels having different dimensions can also be produced from one injection molded part. Such mat-shaped injection molded parts are in particular advantageous when individual pieces are produced.

According to another advantageous embodiment of the invention, a mat-shaped injection molded part is produced in a first method step, having a surface with recesses, wherein the surface between two recesses can be used as a marking label, the length of which can be adjusted as desired in the second method step.

As a result of the fact that the width of the marking labels has already been adjusted in the first step during the injection molding process, only the length of the marking labels has to be adjusted in the second method step, so that the cost of the second method step can be reduced. Such mat-shaped injection molded parts are in particular advantageous when similar marking labels are produced in larger quantities.

The invention further relates to a device for producing marking labels, in particular marking labels for marking electronic components, comprising an injection molding machine for producing a mat-shaped injection molded part and a processing machine integrated in the injection molding process of the injection molding machine, wherein the mat-shaped injection molded part can be produced to form marking labels having variable widths and/or variable lengths in the processing machine. As a result of the fact that, according to the invention, a processing machine is integrated in the injection molding process of an injection molding machine, the injection molding process, and thus also the injection molding machine, in particular the injection molding tool, can be configured in a simplified manner because tasks which otherwise are carried out by the injection molding machine, such as introducing perforations, can be accomplished by the downstream processing machine. The actual injection molding process can thus be designed in a simplified and cost-effective manner. In addition, as a result of the fact that the final dimensions of the marking labels are not already determined by the injection molding tool during injection molding, but not until the second method step by the processing machine, a uniform injection molding tool can be used for all marking labels. It is thus no longer necessary to produce a separate injection molding tool for each marking label, whereby it is possible to achieve a considerable cost reduction because the injection molding tool is one of the most expensive components of the injection molding machine. Moreover, the method according to the present invention is very flexible because the widths and/or the lengths of the marking labels can be adjusted individually and quickly because this can be carried out independently of the injection molding tool used.

According to an advantageous embodiment of the invention, the processing machine is a cutting device, a punching device and/or a perforating device. By means of the cutting device, the punching device and/or perforating device it is easily and cost-effectively possible to create the desired dimensions of the marking labels to be produced, wherein special dimensions for each individual marking label are easy to create, whereby high flexibility can be achieved during manufacturing. Special embodiments of the marking labels, such as grooves, predetermined breaking points or cut-outs, thus no longer have to be taken into account in the design of the injection molding tool, but can be simply and cost-effectively be introduced into the marking labels in a separate working step.

Another advantageous embodiment of the invention provides for a gripper to be provided, which removes the mat-shaped injection molded part molded in an injection molding tool of the injection molding machine from the injection molding tool and subsequently feeds the removed mat-shaped injection molded part to the processing machine. To this end, the gripper is preferably arranged directly between the injection molding tool of the injection molding machine and the processing machine, so that the gripper has to cover the shortest possible path while transporting the mat-shaped injection molded part, and the gripper can insert the mat-shaped injection molded part directly into the cutting device, the punching device and/or the perforating device.

Preferred embodiments of the invention will be described in more detail below with reference to the attached drawings.

The drawings show:

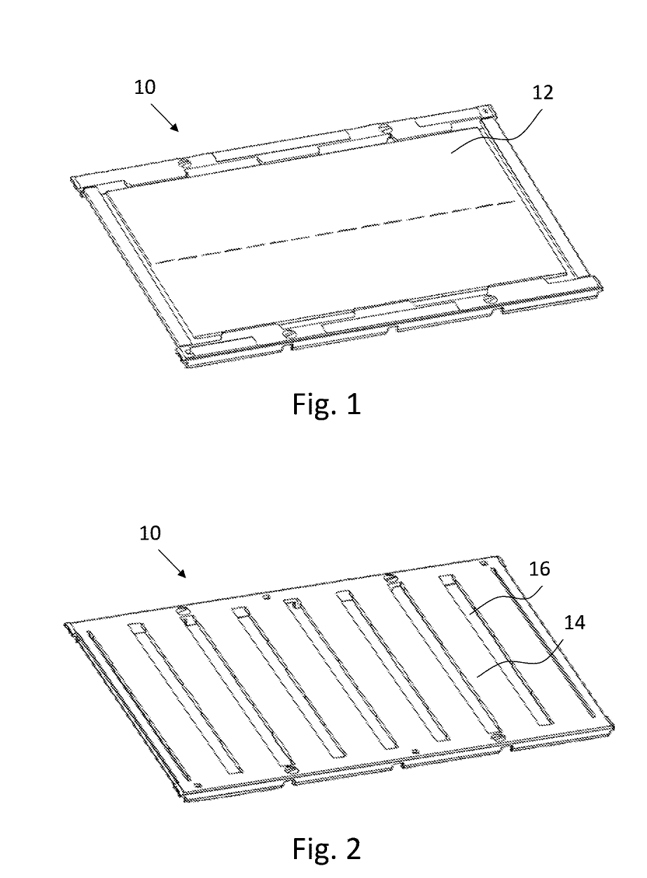

FIG. 1 a schematic illustration of a first embodiment of a mat-shaped injection molded part produced according to the present invention, and

FIG. 2 a schematic illustration of a second embodiment of a mat-shaped injection molded part produced according to the present invention.

FIG. 1 shows a mat-shaped injection molded part 10 produced in a first method step according to the present invention, comprising a one-piece surface 12, from which marking labels having any arbitrary width and/or length can be produced in a second method step. In a first method step, the mat-shaped injection molded part 10 is produced by means of an injection molding process in an injection molding machine. As soon as the mat-shaped injection molded part 10 has cured in the injection molding tool of the injection molding machine, the injection molded part 10 is inserted into a processing machine by means of a gripper, where the mat-shaped injection molded part 10 is cut, punched and/or perforated to form marking labels having any arbitrary widths and/or lengths in a second method step. The mat-shaped injection molded part can be cut, punched and/or perforated by means of a laser, or also by means of a cutting knife, a punching knife and/or a perforating means.

The mat-shaped injection molded parts shown in FIG. 1 have particularly high flexibility when they are further processed because several marking labels having different dimensions can be produced from one injection molded part. Such mat-shaped injection molded parts are in particular advantageous when individual pieces are produced.

FIG. 2 shows another possible embodiment of a mat-shaped injection molded part according to the present invention, which comprises a surface 14 having recesses 16, wherein the surface 14 between two recesses 16 can be used as a marking label, the length of which can be adjusted as desired in the second method step. In this case, this mat-shaped injection molded part 10 is likewise produced by means of an injection molding process, wherein however the injection molding tool is preferably designed such that the recesses 16 contained in the injection molded part 10 are already introduced during the injection molding process. As a result of the fact that the width of the marking labels has already been adjusted in the first method step during the injection molding process, only the length of the marking labels has to be adjusted in the second method step by cutting, punching and/or perforating so that the cost of the second method step can be reduced. Such mat-shaped injection molded parts are in particular advantageous when similar marking labels are produced in large quantities.

In such cases, it is also possible for the marking labels produced by the method according to the present invention to be profiled on the undersides thereof, for example in the form of small fastening bases arranged at an angle relative to one another, which are used for attaching the marking labels to the electronic components. By accordingly designing the injection molding tool, such profiles are preferably created in the first method step during injection molding of the mat-shaped injection molded part.

### REFERENCE NUMERALS

| | |
|---|---|
| Injection molded part | 10 |
| Surface | 12 |
| Surface | 14 |
| Recess | 16 |

1. A method for producing marking labels for marking electronic components, wherein a mat-shaped injection molded part is produced by means of an injection molding process in a first method step, and marking labels having any arbitrary width and/or length are produced from the mat-shaped injection molded part in a second method step.

2. The method according to claim 1, wherein the mat-shaped injection molded part is produced in the first method step such that the marking labels produced from the mat-shaped injection molded part in the second method step are profiled on the undersides thereof for attachment of the marking labels to the electronic components.

3. The method according to claim 2, wherein the profiles are configured as small fastening bases that are arranged at an angle relative to one another.

4. A method according to claim 1, wherein the mat-shaped injection molded part is cut in a cutting device, punched in a punching device and/or perforated in a perforating device in the second method step.

5. The method according to claim 4, wherein the mat-shaped injection molded part molded in an injection molding tool in the first method step is removed from the injection molding tool by means of a gripper, and the removed mat-shaped injection molded part is fed to the cutting device, the punching device and/or the perforating device by means of the gripper to carry out the second method step.

6. The method according to claim 4, wherein the mat-shaped injection molded part is cut, punched and/or perforated by means of a laser.

7. A method according to claim 1, wherein a mat-shaped injection molded part is produced in the first method step, comprising a one-piece surface, from which marking labels having any arbitrary width and length can be produced.

8. A method according to claim 1, wherein a mat-shaped injection molded part is produced in a first method step, comprising a surface having recesses, wherein the surface between two recesses can be used as a marking label, the length of which can be adjusted as desired in the second method step.

9. A device for producing marking labels for marking electronic components, comprising an injection molding machine for producing a mat-shaped injection molded part and a processing machine integrated in the injection molding process of the injection molding machine, wherein the mat-shaped injection molded part can be turned into marking labels having any arbitrary width and/or any arbitrary length in the processing machine.

10. The device according to claim 9, wherein the injection molding machine is designed for producing the mat-shaped injection molded part such that the marking labels produced from the mat-shaped injection molded part in the processing machine are profiled on the undersides thereof for attachment of the marking labels to the electronic components.

11. The device according to claim 10, wherein the profiles are configured as small fastening bases that are arranged at an angle relative to one another.

12. A device according to claim 9, wherein the processing machine is a cutting device, a punching device and/or a perforating device.

13. A device according to claim 9, wherein a gripper is provided, which removes the mat-shaped injection molded part molded in the injection molding tool of the injection molding machine from the injection molding tool and subsequently feeds the removed mat-shaped injection molded part to the processing machine.
